(19) United States
(12) Patent Application Publication
(10) Pub. No.: US 2007/0017218 A1
(43) Pub. Date: Jan. 25, 2007

(54) Engine / compressor of compressed gas of free piston and freewheel

(76) Inventor: Armando Miguel Regusci Campomar, Maldonado (UY)

Correspondence Address: LADAS & PARRY, 26 WEST 61ST STREET, NEW YORK, NY, 10023, US

(21) Appl. No.: 11/491,304

(22) Filed: Jul. 21, 2006

(30) Foreign Application Priority Data
Jul. 22, 2005 (UY) U4072
Nov. 11, 2005 (UY) U4097
Mar. 20, 2006 (UY) U4117
Mar. 20, 2006 (UY) U4118

(51) Int. Cl. F16D 31/02

(52) U.S. Cl. 60/370

(57) ABSTRACT

Improvements in Compressor/Engine of compressed gas of free piston and freewheel that can be connected and disconnected from shaft of the engine, eventually a inclusion of a gear box and a calorific energy that can be applied to vehicles and stationary systems

### TECHNICAL AREA

The object of the present request belong to the area of the self-propelled in general and to the use of compressed gas like an propeller element, ways for optimization of it use and recovery the potential energy.

Records

The Present form is about the improvements about the construction of the object Application of the Patent of the model of utility Act N^{o} 3987 about: “The Engine of compressed gas of free piston and freewheel of double effect for high speed of the vehicle”

There is no record of this patent

### DESCRIPTION

In concordance with the exposed there is a collection of improvements

Connecting and Disconnecting

In this aspect the proposal has the following elements and variants

Variant 1

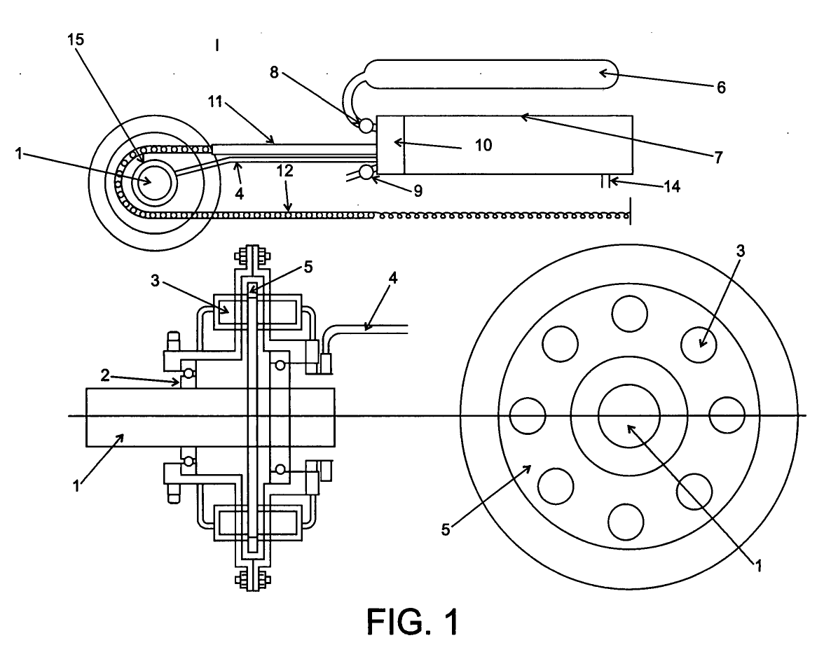

In the FIG. 1 the following elements appear
Shaft of the engine
2 bearing
3 piston
4 pipe
5 disk
6 tank
7 cylinder
8 valve
9 valve
10 piston
11 shaft
12 chain
13 spring
14 opening
15 freewheel

How it works:

When the piston is in the left side as it appears in the drawing 1, the valves 8 and 9 closed and the shaft 1 stops without movement it opens the valve 8, the gas comes from the tank 6 and pushes the piston 10 to the right side, the piston pulls from the shaft 11, the one that pulls chain 12, the one that makes spin the freewheel 15. This freewheel when it takes the gas pressure through the pipe 4 pushes the piston 3 and connects the pneumatic freewheel to the disk 5, it receive the mechanical rotational energy that makes spin the shaft 1, the pipe 4 is connected to the camera of the cylinder to receive pressure.

When the piston receives pressure it closes the valve 8, the gas expands. When the pressure reaches the atmospheric pressure the piston stops doing force and the piston 3 fallback due to the force of the spring and the freewheel releases the disk 5, the cylinder 7 has an opening 14 that allows the gas to escape. When the piston arrives to the end with pressure so the freewheel does not stay connected to the freewheel, the shaft continues spinning even when the freewheel is stopped

The valve 9 opens and the piston falls back until it gets to the final path towards left, taken by the spring 13.

A new cycle begins, the valves can be opened manually or by computer with electronic valves or a mechanical system, choosing the moment most appropriate to open and shut the valves.

When we mention freewheel we are referring to what was called freewheel or pinion. Know there is a mechanism of attachment and disattachment that works as if it was a freewheel if connects and disconnects in the right moment, but it can do more functions rather than a normal freewheel, when it receives or sends energy in both way. Another of the reasons of why this mechanism is used is because of reasons of economy and duration of the freewheel it has to work so many times before it end breaking or it can be very expensive, or both. In this way with the attachment with the type of disk brake the pills waste, the ones that can be changed are more cheap than the other ones.

Also the freewheel to connect and disconnect can receive gas pressure from another side of the valves with the appropriate valves that can do that

Variant 2:

Compressor of Free Piston and Freewheel:

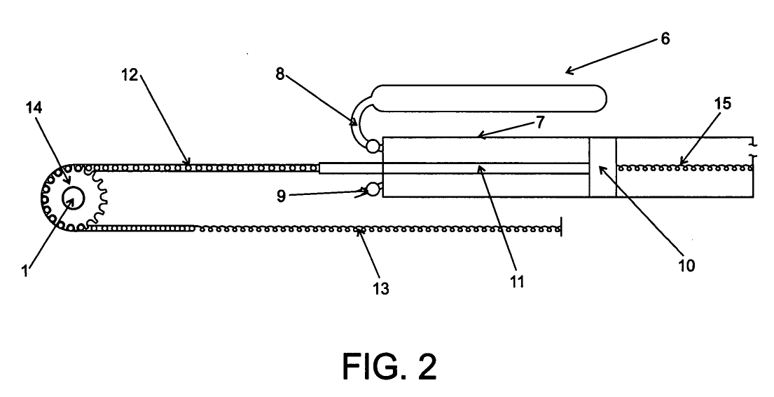

In the FIG. 2 there are the following elements
1. Shaft of the compressor
6. Tank
7. Cylinder
8. Valve
9. Valve
10. Piston
11. Shaft
12. Chain
13. Spring
14. Freewheel
15. Spring
   How it works

When the shaft 1 is spinning in counterclockwise direction, the freewheel 14 disconnected from shaft 1, the piston 10 to the right of the cylinder, the freewheel connects with shaft 1 through a pneumatic system or a electromagnetic system, the freewheel 14 pulls from chain 12 towards the left, the chain 12 pulls from shaft 11, the shaft 11 pulls the piston 10 towards the left, the gas is in the cylinder 7 it passes through the valve 8 towards the tank 6, the valve 8 lets the gas pass from the cylinder 7 to the tank 6 but not from tank 6 to cylinder 7, the valve 9 permits the passage of the gas to the cylinder 7 but not from the cylinder 7 to the atmosphere or to another place.

When the piston arrives to the left side of its path the freewheel 14 disconnects from the shaft 1.

As the spring 15 has more force than the spring 13, the piston 10 moves now towards the right until it reaches the final path towards the left so the cycle can start over again. If we put the cylinder vertical with the freewheel higher than the cylinder and the piston has more weight of the object that adds to the final chain 12 instead of the spring 13, the result is the same.

Variant 3:

Compressor Engine of Free Piston and Freewheel:

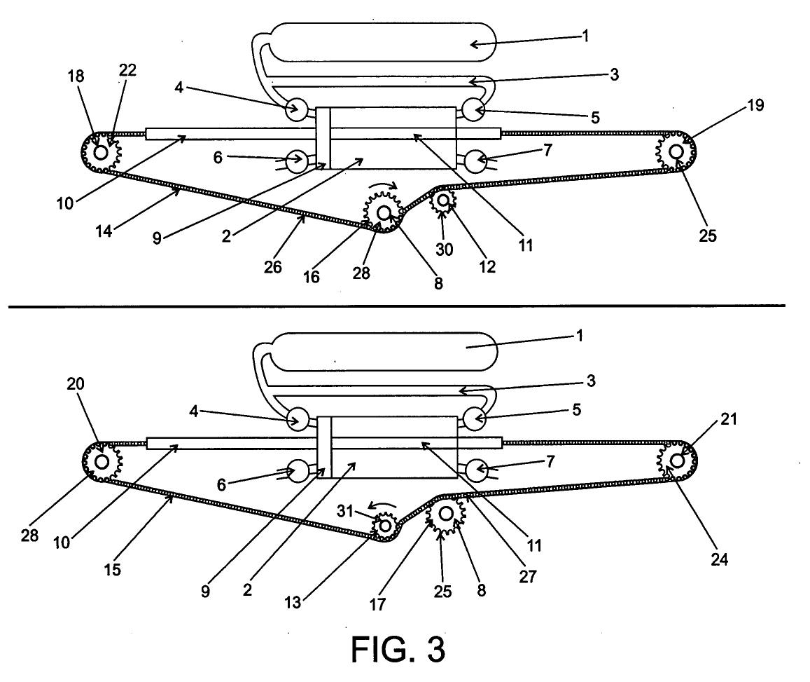

In the FIG. 3 the following elements appear:
1 tank,
2 cylinder,
3 pipes,
4 valve,
5 valve,
6 valve,
7 valve,
8 shaft of the engine compressor,
9 piston,
10 shaft,
11 shaft,
12 guide,
13 guide,
14 chain,
15 chain,
16 freewheel,
17 freewheel,
18 guide,
19 guide,
20 guide,
22 guide,
23 guide,
24 guide,
25 guide,
26 chain,
27 chain,
28 freewheel,
30 guide,
31 guide.
   Functioning

When the piston 9 is in the left side as it appears in the drawing, the vehicle is stopped, the valves 4, 5 and 6 closed and the valve 7 open, the valve 4 opens, the compressed gas that is in the tank 1 passes through the pipe 3 and the valve 4 and pushes the piston 9 towards the right, it pulls the shaft 10, it pulls the chain 14, it makes the freewheel 16 spin clockwise. Because we have a system that connects and disconnects the freewheel 16 with the shaft of the engine 8 when we want, when the piston starts to do force we connect the freewheel and the engine delivers the energy to the shaft 8.

The guides 18, 19 and 12 can be used to change the direction of the force of the chain 14, the chain 14 goes with the shaft 11 to support with certain tension, being able to use the system to maintain the chain with certain tension as the mechanism that is used to gear change in bikes.

The shaft 10 pulls from the chain 15, that makes the freewheel 17 spin counterclockwise. Because we have a system that connects and disconnects when we want the freewheel 17 of the engine shaft 8 maintain the freewheel 17 disconnected from the engine shaft 8, spinning the freewheel 17 counterclockwise and the engine shaft spinning clockwise, the guides 13,20 and 21 are used to change the direction of the forces in which the chain works, the chain 15 goes along with the shaft 11 to maintain with certain tension using the same mechanism than the chain 14.

The chain 26 and its elements work in the same way than the chain 14, it is used to maintain the forces symmetrical.

The chain 27 and its elements work in the same way as the chain 15, it is used to maintain the forces symmetrical

When the amount of air is enough that entered the cylinder 2 the valve 4 and the gas expands in the cylinder 2, when the piston arrives to the end of the path the freewheels 16 and 28 disconnect.

The valve 7 closes, the valve 5 opens and the freewheels 17 and 29 connect. The piston now works to the right, once it arrives right of the path it disconnects the freewheels 17 and 29 and the cycle starts again.

When the four freewheels are disconnected the vehicle can spin freely without moving the piston.

For the vehicle to work as a compressor the following has to be done:

When the engine shaft 8 is moving clockwise the four freewheels disconnected and the four valves closed.

When the piston is on the left side the valve 6 open and the freewheels 16 and 28 connect, the shaft 8 is going to pull by the chains the shaft 11 that pulls the piston 9 to the right. The gas in the cylinder 2 passes through one of the valves of no return to the pipe 3 and from there to the tank 1, this valve of no return lets the gas pass from the cylinder 2 to the pipe 3 but not from the pipe 3 to the cylinder 2, at the same time the gas enters the valve 6 to the cylinder 2.

When the piston arrives to the right side of its path it disconnects the freewheels 16 and 28, the valve 6 closes, the valve 7 opens and connects the freewheels 17 and 29, the gas in the cylinder 2 passes a valve of no return to the pipe 3 and from there to the tank 1. This valve of no return lets the gas from the cylinder 2 to the pipe 3 but not from the pipe 3 to the cylinder 2, at the same time the gas enters from the valve 7 to the cylinder 2.

When the piston arrives to the left of its path all the freewheels disconnect and the cycle start over.

The time of the valves can change to adjust the power of the compressor. This compressor lets recover the energy of the brake of the vehicle.

It also permits the vehicle to go in reverse

It also lets to make little movements letting the piston fallback with a spring towards a side, when we disconnect the freewheels and make the engine behave like an engine of variant 1.

Also it lets connect an electric motor on the vehicle so it can compress gas in the tanks.

Also it can be used as a stationary compressor connected to a electric motor or any type of mechanical rotational energy, and it can be used as a generator

Also it can be connected to a electric motor to the wheels of the vehicle so it can later put in the tanks to charge it's self.

These type of compressors can be connected to any source of rotational energy as windmills or other to compress gases.

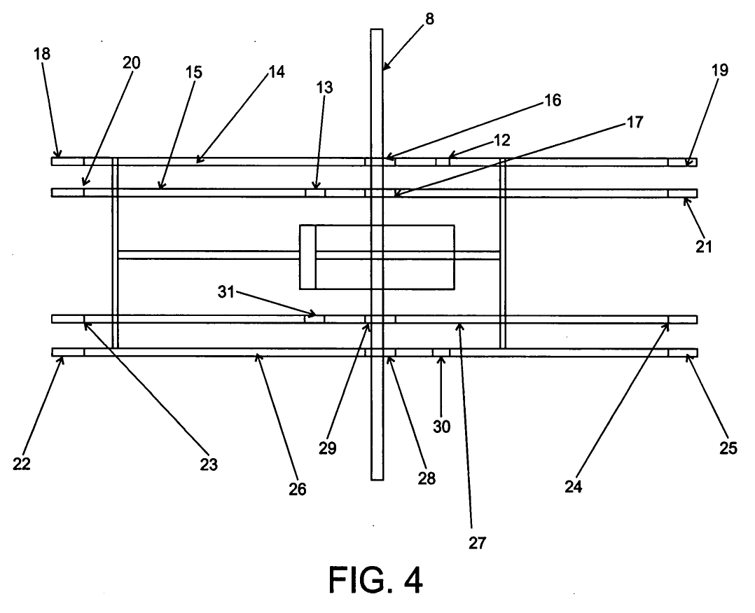

In the FIG. 4 there are elements of the variant 3 seen in vertical projection instead of a horizontal projection just like in the FIG. 3.

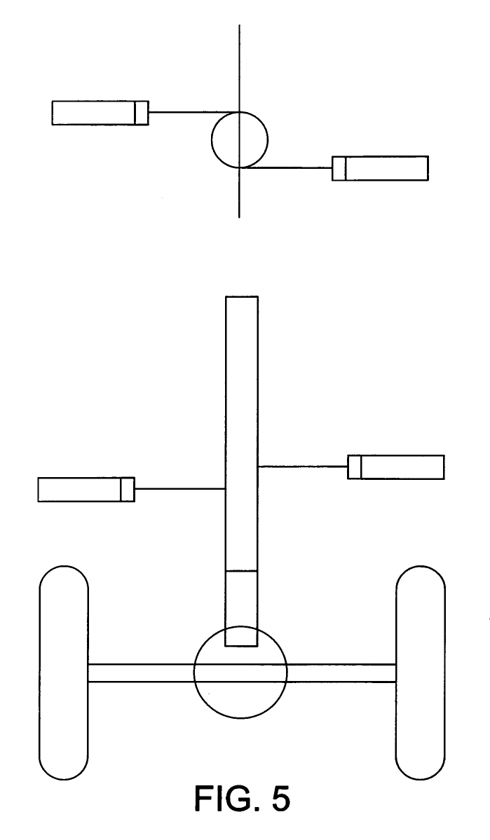

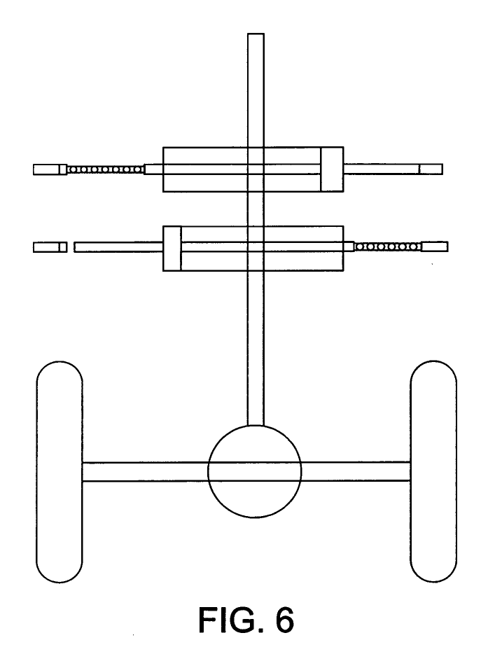

In the FIG. 5 there is the variant 1 of the engine connected to a joint of a vehicle. We have to emphasize about the forces that are applied to the joint in the possible in the same direction and opposite sense to create a even in the joint

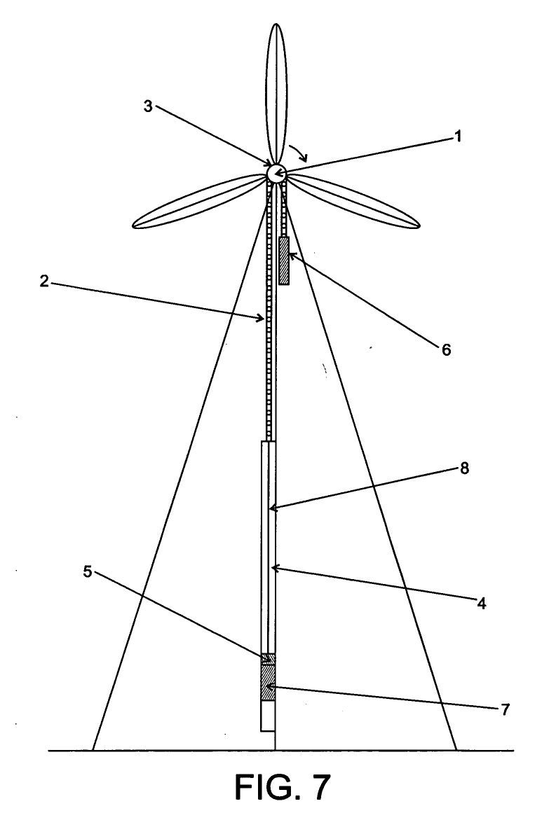

In the FIG. 7 appears a compressor of type 2 variant connected to a windmill, in which there are the following elements 1 shaft of the engine, 2 chain, 3 freewheel, 4 cylinder, 5 piston, 6 counterweight, 7 weight. We can put heat exchangers in the structure of the windmill to increase the efficiency.

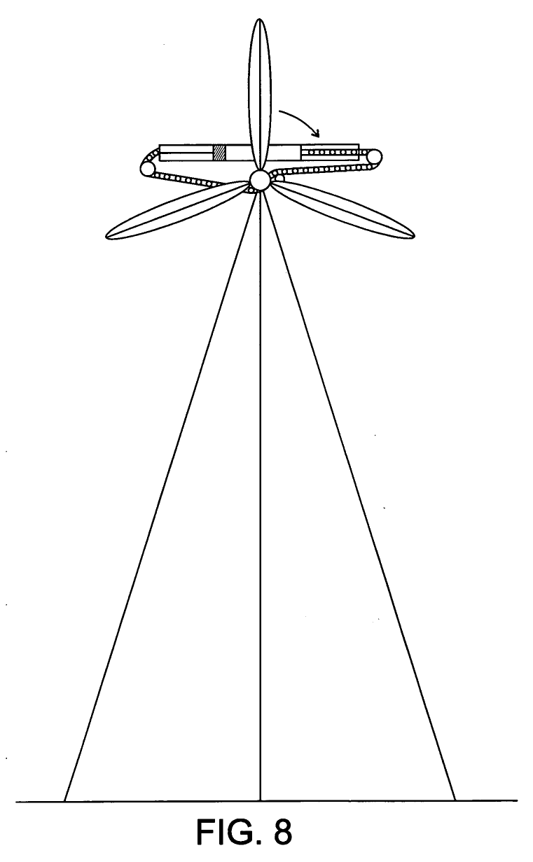

In the FIG. 8 a compressor of variant 3 appears connected to a windmill.

In these windmills you can place a electrical motor to send and receive energy from the electrical network.

Variant 4:

Compressor Engine of Free Piston and Free Wheel with Fastener:

It can be connected with a fastener to a piston to two freewheels in the way that when the piston moves the freewheels spin counterclockwise one another.

In the Uruguayan patent “Engine of compressed gas and free piston and freewheel of double effect for high speed of the vehicle” (Act 3987) of double effect for high speed of the vehicle there can bee seen various examples of application of this patent changing the freewheel for a freewheel attachable and disattachable to the shaft of the engine.

The vehicle could have two pedals, accelerator and brake that can be controlled digitally giving then a order to the computer that would be in charge of opening and closing the valves and connecting and disconnecting the freewheels in most convenient way.

Also it could break compressing the air when the brake is pushed soft it can use the air to stop or when the brake is pushed hard it uses a disk brake or another type of braking system.

Eventual inclusion of gear box:

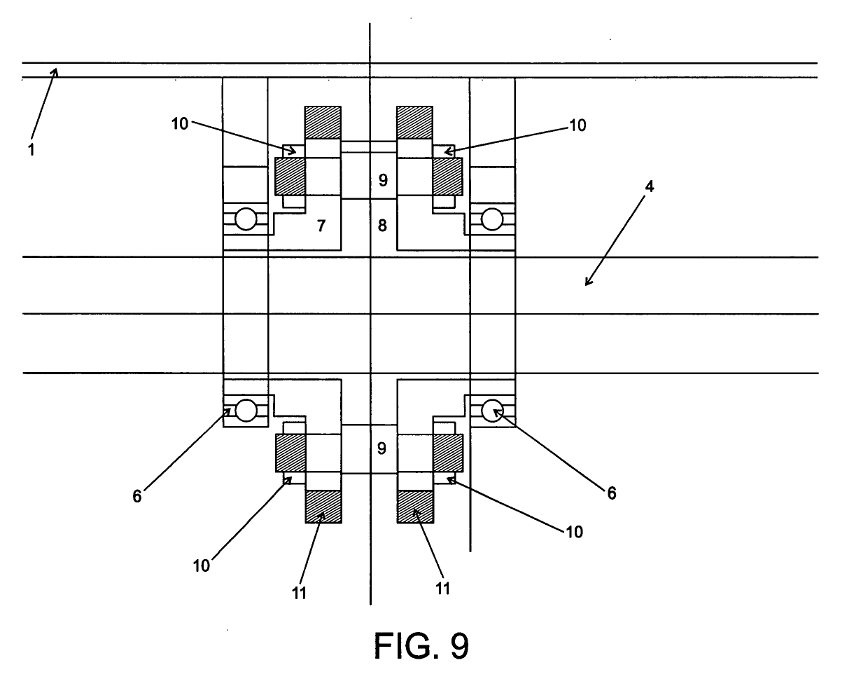

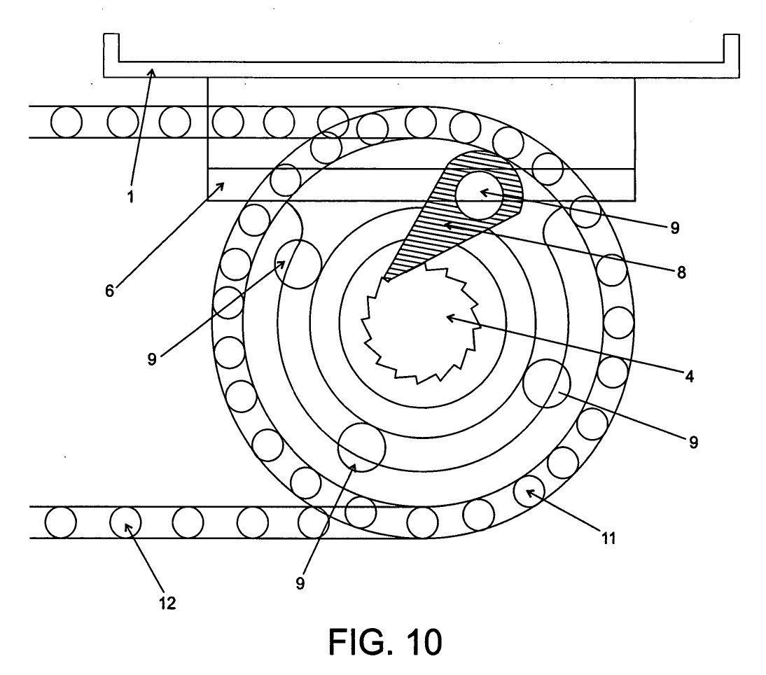

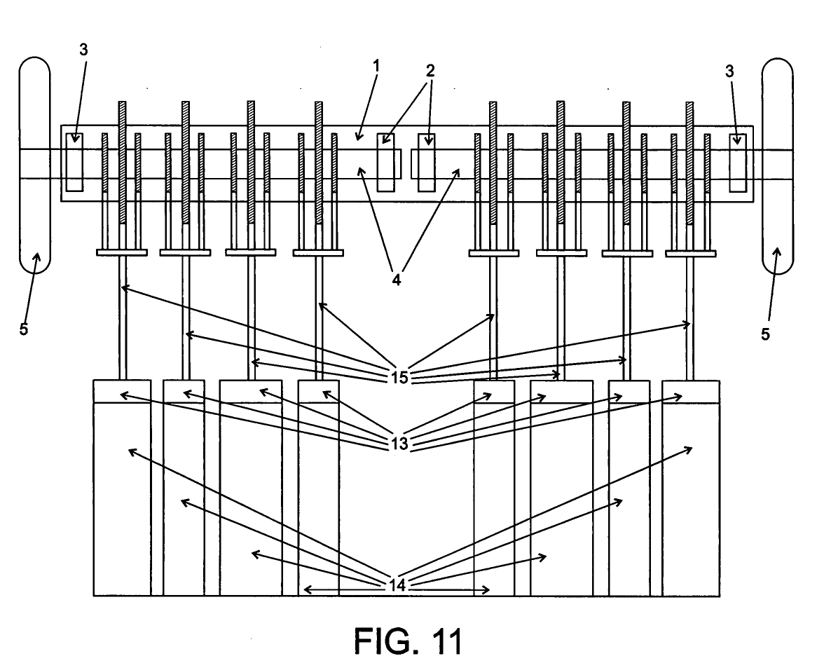

In the FIG. 9, 10 and 11 the element 1 appears consisting in 1 bar of steel in U form It also can be in another form or material. This bar is connected to the vehicle through a suspension or not.

Also there can be 2 independent bars.

Connected to that bar are the omega bearing 2 and 3 which lets the shaft 4 spins that goes connected with the wheel 5.

Connected to that bar go the omega bearings 2 and 3 that let the shaft 4 spin that is connected to the wheel 5.

Connected to the steel bar 1 are so many freewheels as pistons that the engine has.

The freewheels are the connectable and disconectable type or not. Each freewheel has 2 omega bearings connected to the bar 1 that lets the element 7 spinn.

The element 7 has one or a lot of crowns 11 where one or a lot chains 12 and one or many trigger 8 work. The triggers are triggered by springs or electromagnets or other system.

The 4 shafts have slot along them.

The crowns can be same or different diameter.

The bolt 9 maintains connected the element 7 by the nuts 10.

The bolt 9 is used to spin the trigger 8.

Functioning

Case 1:

The crowns are same diameter:

When the triggers 8 of all freewheels without touching the shafts 4 thanks to a spring in every trigger that docent let it touch, being every freewheels disconnected and the vehicle stopped.

A electromagnet is triggered in one of the freewheels and the trigger 8 of that freewheel touches the shaft 4.

The valve is opened from the piston 13 that corresponds to that freewheel and the piston 13 of that freewheel pulls the shaft 15 of that freewheel and the shaft 15 of that freewheel of the chain 12 of that freewheel and these spin the crown 11 of that freewheel that corresponds. These crowns spin the element 7 that spins the one or more triggers 8.

One or more triggers 8 make spin the shaft 4 the one that makes the wheel spin and the vehicle starts moving.

When piston arrives to end of its path being the trigger connected to shaft 4, the shaft 4 can continue spinning without problem. Now the shaft 4 is spinning.

Also you can start the movement by one or all of the pistons.

The triggers are connected and disconnected when ever we want of the rest of the freewheels

One of the reasons to disconnect the triggers is when we want to move in reverse in the vehicle. All of the triggers must be disconnected and through a system any can go in reverse.

It can be a freewheel that pulls in reverse direction or in another method.

Also the springs can be used to maintain the triggers always connected.

Case 2:

The Crowns in a same piston are different in diameter.

Suppose we have a freewheel with 3 crowns of different diameter. It would be like if the freewheel had 1, 2 and gear

When we trigger the electromagnet from the triggers that connect the element 7 with the shaft 4 that corresponds, to or to the crowns of bigger diameter and leaving the rest of triggers of that freewheel without connecting. In that way that freewheel is going to work as 1 gear to gear up to second gear and third gear the same thing will be done for the other crowns.

Each piston could work independently in the gear that you wish, creating a great variety of gears.

For the reverse all the freewheels that pull forward are disconnected

To assemble this system first all the freewheels are put in the element 1 and then the shaft 4 is placed.

Finally the bearing 2 and 3 are placed.

In this model of utility the explained is applied the Uruguayan model of utility Act N^{o} 4072 named engine and or compressor of compressed gas of the free piston and freewheel of freewheel connectable and disconectable.

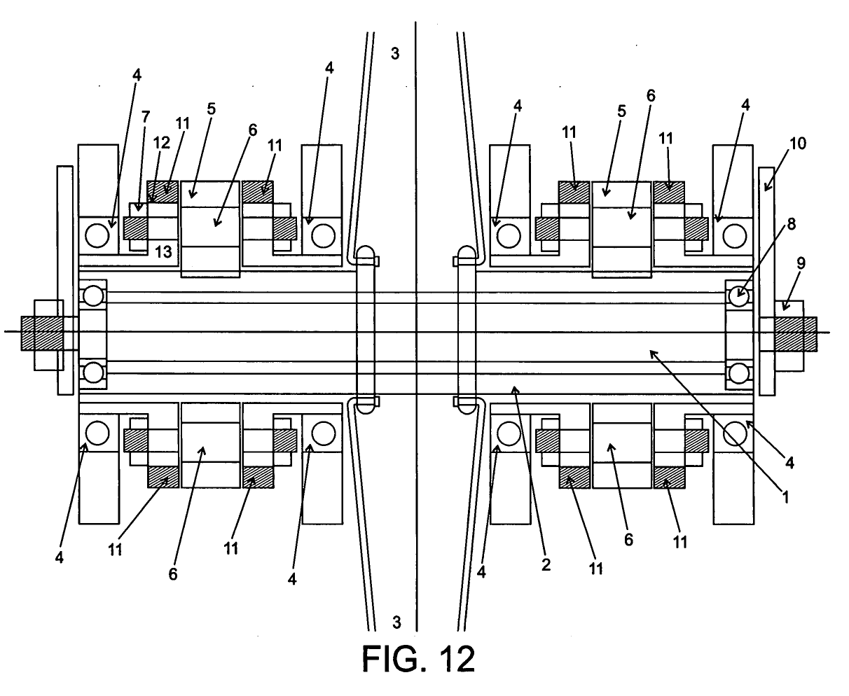

In the FIG. 112 there is a similar system to the previous but applied on a motorcycle that has following elements:
1 Shaft,
2 Shaft with slots,
3 Back wheel of the motorcycle,
4 Omega Bearing,
5 Trigger,
6 Shaft,
7 Nut,
8 Bearing,
9 Nut,
10 Support,
11 Crown for chain,
12 Chain,
13 element
   Functioning:

When the trigger 5 is connected to the chain 12, it pulls from the crown 11, that makes the element 13 spin. The element 13 makes the trigger 5 spin the trigger 5 makes the shaft 2 spin. The shaft 2 makes the wheel 3 spin.

The omega bearings 4 are connected to the chassis of motorcycle. The shaft 1 is connected to the chassis of the motorcycle thru the nut 9 and the support 10.

Eventual Utilization of Calorific Energy:

Functioning:

On a vehicle a engine is placed and or a compressor of free piston and freewheel or another, tanks of compressed gas and a gaseous substance liquid or solid at a superior temperature than the ambient temperature. Through a correct Mechanism the calorific energy the gas that is in the engine may be used to give more energy to the vehicle.

The same system can be applied to a stationary system.

### EXAMPLE 1

A water heater of 10 liters with its plug and insulation. The temperature in the water is raised 20 to 90 Celsius degrees. Given that a calorie is required energy to raise the temperature of one gram of water in one Celsius degree and one calorie is 4.184 Julius of energy, the calorific energy in 10 liters of water is 700000 calories or 2928800 Julius or 0.81 KWH.

With a water pump that makes the water circulate from the water tank to the exterior of the cylinders heating up the gas inside them. What makes the internal energy to raise. Is the law of Gay Lussac That states PV=NRT.

### EXAMPLE 2

The gas in compressed and instead of putting a ventilator and throwing the calorific energy to the atmosphere, the water heats up and then the water is placed on the vehicle, using the energy in same way as in the example 1.

### EXAMPLE 3

On a vehicle water is placed and is heated up with some sort of inflammable material. Then the calorific energy is used in same way as in the example 1.

1. Compressor/Engine of compressed gas of free piston and freewheel, characterized by a freewheel that spins around the shaft of the engine it is connectable and disconnectable to the shaft of the engine, and a piston and or pistons of equal or different diameter letting the piston work in simple or double effect

2. Compressor/Engine of compressed gas by the claim 2 characterized for having various freewheels spinning in the same or different direction for every piston of simple or double effect

3. Compressor/Engine of compressed gas by the claim 1 in which the transmission of the movement between the piston or the freewheels that can be done by any known way

4. Compressor/Engine of compressed gas by claim 1, characterized for only one, some or all pistons the necessary time.

5. Compressor/Engine of compressed gas by claim 1, characterized because the freewheels are different diameters in which the speed of the freewheel can be changed with respect to the speed of the piston, choosing which freewheels are connected and which are not connected

6. Compressor/Engine of compressed gas by claim 1, characterized by being applied to a vehicle.

7. Compressor/Engine of compressed gas by claim 1, characterized for being applied to a stationary system, which can be connected to a windmill, to generate electricity or for any other convenient application

8. Compressor/Engine of compressed gas by claim 1, characterized for having incorporated a gear box a clutch and a differential between the wheels of vehicle and the engine.

9. Compressor/Engine of compressed gas by claim 1, characterized for having change of relation of speeds between the piston and the shaft it has the same path of the piston.

10. Compressor/Engine of compressed gas by claim 1, characterized for being able to be placed and removed without having to take the freewheels out

11. Compressor/Engine of compressed gas by claim 1, characterized for having the compressed gas tanks and substance a higher temperature than ambient, in such way that (in case of the motor) a mechanism that lets the energy be transferred from that substance to the gas that is inside of that engine, to give higher energy to the gas in a way to give more energy to the engine.

12. Compressor/Engine of compressed gas by the claim 11, characterized for having calorific energy obtained of the compression of the gas that is used in the vehicle or in other vehicles.

13. Compressor/Engine of compressed gas by the claim 12, characterized fo having calorific energy obtained from the combustion of some substance in the vehicle or outside of it.

14. Compressor/Engine of compressed gas by claim 1, characterized for using utilizes it self as a secondary brake convectional to compress gas, to gain energy or only brake.

15. Compressor/Engine of compressed gas by claim 1, characterized for eventually the gas can be inflammable with a ignition that help produce movement.
